(19) United States
(12) Patent Application Publication
(10) Pub. No.: US 2026/0183863 A1
(43) Pub. Date: Jul. 2, 2026

(54) METHOD FOR MANUFACTURING JOINED BODY

(71) Applicant: FUTABA INDUSTRIAL CO., LTD., Okazaki-shi (JP)

(72) Inventors: Tomohiro Katsura, Okazaki-shi (JP); Shoichi Kawano, Okazaki-shi (JP); Yusuke Kito, Okazaki-shi (JP)

(21) Appl. No.: 19/428,752

(22) Filed: Dec. 22, 2025

(30) Foreign Application Priority Data
Dec. 27, 2024 (JP) 2024-232982

(51) Int. Cl. B23K 11/11

(52) U.S. Cl. CPC B23K 11/115

(57) ABSTRACT

One aspect of the present disclosure provides a method including: clamping a first combination of metal workpieces between a first pair of electrodes; and applying a welding current between the first pair in accordance with a preset current profile over time, the preset current profile being divided into (i) a high current application period, and (ii) a main current application period after the high current application period, the high current application period being a period during which a magnitude of the welding current is gradually reduced from its maximum value to a required value for welding the first combination to blow contaminants off the first combination, the main current application period being a period during which the magnitude of the welding current is reduced from the required value more gradually than during the high current application period to weld the first combination.

### CROSS-REFERENCE TO RELATED APPLICATIONS

This application claims the benefit of Japanese Patent Application No. 2024-232982 filed on December 27, 2024 with the Japan Patent Office, the entire disclosure of which is incorporated herein by reference.

### BACKGROUND

The present disclosure relates to a method for manufacturing a joined body.

Japanese Unexamined Patent Application Publication No. 2021-169114 discloses performing a main energizing followed by a subsequent energizing in the manufacture of a resistance-welded member that includes a high-tensile-strength steel sheet. In the main energizing, a current is applied to the resistance-welded member at a first current value for approximately 400 milliseconds to form a nugget. In the subsequent energizing, the magnitude of the current flowing through the resistance-welded member is gradually reduced from the first current value at a constant rate of change. Through such a method, occurrence of a molten-metal brittle crack, such as an internal crack of a nugget, can be suppressed.

### SUMMARY

In the above method, however, a welding spatter is prone to be generated during the main energizing.

The welding spatter is generated when a molten metal is ejected from the resistance-welded members and scattered on surrounding area of the resistance-welded members, due to contaminants contained in the resistance-welded members or irregularities on surfaces thereof. The welding spatter tends to be generated more readily when a resistance-welded member including a high-strength steel sheet, such as hot stamped steel sheet and high-tensile-strength steel sheet.

In one aspect of the present disclosure, it is desirable to reduce occurrence of welding spatter during a main current application to a high-strength steel sheet.

One aspect of the present disclosure provides a method for manufacturing a joined body, the method comprising:

clamping (or interposing or disposing or sandwiching) a first combination of metal workpieces between a first pair of electrodes, the first combination of metal workpieces including a high-strength steel sheet (or a high-strength steel plate); and

applying (or supplying or passing) a welding current between the first pair of electrodes in accordance with a preset current profile over time, the preset current profile being divided into (i) a high current application period; and (ii) a main current application period after the high current application period, the high current application period being a period during which a magnitude of the welding current is gradually reduced from its maximum value to a required value for welding the first combination of metal workpieces to blow contaminants off the first combination of metal workpieces, the main current application period being a period during which the magnitude of the welding current is reduced from the required value more gradually than during the high current application period to weld the first combination of metal workpieces.

Such a method makes it possible to blow contaminants off the first combination of metal workpieces during the high current application period. Additionally, it is possible to flatten surfaces of the first combination of metal workpieces during the high current application period.

Thus, through this method, it is possible to reduce occurrence of welding spatter during the main current application period.

During the high current application period, due to a large welding current flowing through the first combination of metal workpieces, a clearance can be formed between the metal workpieces around a welded portion of the metal workpieces. This causes the welding current to be concentrated at the welded portion, thereby enabling a reduction in current loss caused by current flowing between the metal workpieces around the welded portion.

Thus, the aforementioned method makes it possible not only to reduce the welding spatter, resulting in improved welding quality, but also to reduce electrical power consumption during welding, resulting in enhanced welding efficiency.

The preset current profile may be set to correspond to a resistance profile between a second pair of electrodes over time. The resistance profile may be measured by (i) clamping (or interposing or disposing or sandwiching) a second combination of metal workpieces between a second pair of electrodes and (ii) applying (or supplying or passing) a constant measurement current (or a fixed measurement current) between the second pair of electrodes. The second combination of metal workpieces may be equivalent to the first combination of metal workpieces.

It is possible, by applying the constant measurement current between the second pair of electrodes, to measure the following properties: a rate at which the second combination of metal workpieces heats up, a timing at which the heating is started, a timing at which the resistance reaches its peak after the heating is started, and a degree of current loss (current division) occurring afterward, as the resistance profile (i.e., variation in the resistance over time (waveform of the resistance)).

Therefore, it is possible, by applying the welding current in accordance with the preset current profile (i.e., variation in the welding current over time (waveform of the welding current)), which corresponds to the resistance profile, to control the magnitude of the welding current such that the resistance between the first pair of electrodes is substantially constant.

Accordingly, for example, unlike as disclosed in Japanese Unexamined Patent Application Publication No. H06-198453, it is unnecessary to control the magnitude of the welding current while measuring the resistance between the first pair of electrodes in order to reduce occurrence of welding spatter. This makes it easy to set the welding conditions for the constant resistance welding. Furthermore, it is possible to reduce processing load incurring in controlling the welding.

The constant measurement current may be set to a value such that no welding spatter is generated on the second combination of metal workpieces.

In this case, the resistance profile is measured such that no welding spatter is generated on the second combination of metal workpieces. This makes it possible to set the magnitude of the welding current such that no welding spatter is generated on the first combination of metal workpieces, resulting in enhanced welding quality of the first combination of metal workpieces.

Applying a welding current between the first pair of electrodes in accordance with a preset current profile over time may comprise using a welding apparatus capable of controlling the magnitude of the welding current with a time resolution on the order of milliseconds.

In such a case, the magnitude of the welding current can be precisely varied in accordance with the preset current profile. As a result, a better constant resistance welding can be achieved.

### BRIEF DESCRIPTION OF THE DRAWINGS

An example embodiment of the present disclosure will be described hereinafter with reference to the accompanying drawings, in which:

FIG. 1 is a schematic diagram of a welding apparatus according to an embodiment;

FIG. 2 shows a welding current profile;

FIG. 3 shows a resistance profile measured;

FIG. 4 is a flowchart of a resistance measurement process; and

FIGS. 5A and 5B are schematic diagrams of workpieces undergoing welding.

### DETAILED DESCRIPTION OF EXEMPLARY EMBODIMENTS

The present embodiment provides a welding apparatus 1.

### Configuration of Welding Apparatus

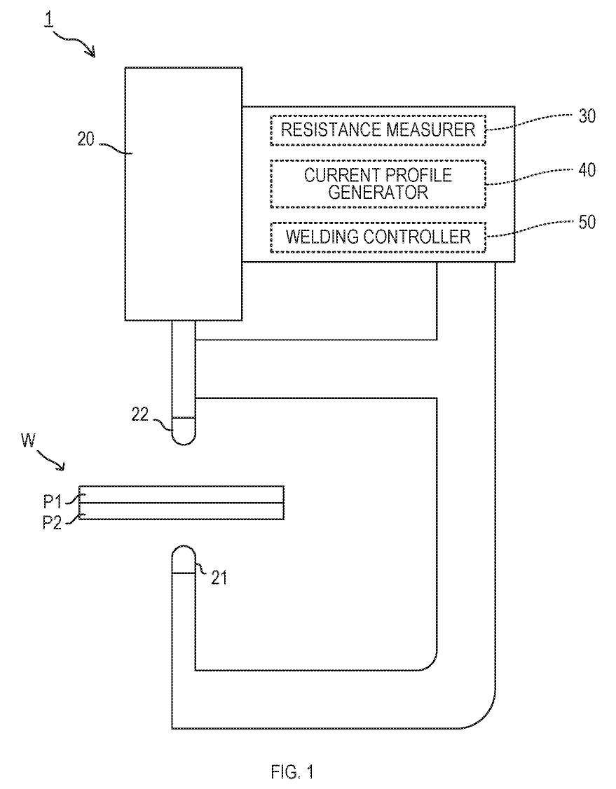

As illustrated in FIG. 1, the welding apparatus 1 is configured to perform a resistance spot welding (RSW) to weld a workpiece W. The workpiece W includes first and second metal workpieces P1 and P2 stacked in layers. Specifically, the welding apparatus 1 manufactures a joined body comprising the first and second metal workpieces P1 and P2.

The first metal workpiece P1 and/or the second metal workpiece P2 is or are a high-tensile-strength steel sheet (or a high-tensile-strength plate) with a tensile strength of 590 MPa (megapascal) or greater, such as a hot-pressed steel and a high tensile strength material.

For example, the first metal workpiece P1 may be a melt zinc-plated steel sheet or a high-tensile-strength steel sheet with a tensile strength of 590 MPa or greater. Alternatively, the first metal workpiece P1 may be a high-tensile-strength steel sheet with a tensile strength of 980 MPa or greater (so-called ultra-high-strength material).

Similarly to the first metal workpiece P1, the second metal workpiece P2 may be, for example, a melt zinc-plated steel sheet, but is not limited to a high-tensile-strength steel sheet. Specifically, the second metal workpiece P2 may be a steel sheet having a lower tensile strength than high-tensile-strength steel sheets. Alternatively, the second metal workpiece P2 may be a high-tensile-strength steel sheet or an ultra-high-strength material, similarly to the first metal workpiece P1.

In the present embodiment, the reason that at least one of the first and second metal workpieces P1 and P2 is a high-tensile-strength steel sheet is because the greater the tensile strength of the first and second metal workpieces P1 and P2 is, the higher an electrical resistance (hereinafter, simply referred to as a resistance) at the overlapping area of the first and second metal workpieces P1 and P2 before welding is.

As the welding apparatus 1 is suitable for welding high-tensile-strength steel sheets as described above, at least one of the first and second metal workpieces P1 and P2 is a high-tensile-strength steel sheet.

However, the welding apparatus 1 can also be used to weld steel sheets having a lower tensile strength than high-tensile-strength steel sheets. In another embodiment, the welding apparatus 1 may weld three or more stacked metal workpieces.

The welding apparatus 1 comprises a resistance welding device 20. The resistance welding device 20 performs resistance spot welding to weld the first and second metal workpieces P1 and P2 in their stacking direction. The stacking direction corresponds to a direction along which the first and second metal workpieces P1 and P2 are arranged or to a normal direction of surfaces of the first and second metal workpieces P1 and P2. The stacking direction is, in other words, along thicknesses of the first and second metal workpieces P1 and P2.

The resistance welding device 20 comprises a first electrode 21 and a second electrode 22. The first electrode 21 is positioned under the workpiece W. The second electrode 22 is positioned above the workpiece W so as to clamp the workpiece W together with the first electrode 21 along the stacking direction of the first and second metal workpieces P1 and P2. The first electrode 21 is movable in a vertical direction (up-down) relative to the second electrode 22.

The first electrode 21 and the second electrode 22 are brought into contact with the workpiece W during welding. The first electrode 21 is brought into contact with the second metal workpiece P2 positioned at the lower region of the workpiece W. The second electrode 22 is brought into contact with the first metal workpiece P1 positioned at the upper region of the workpiece W. The first and second electrodes 21 and 22 together clamp the workpiece W along the stacking direction while applying pressure to the workpiece W from both sides.

The resistance welding device 20 applies a welding current between the first and second electrodes 21 and 22 in either direction with the workpiece W clamped between the first and second electrodes 21 and 22. The workpiece W generates heat due to resistive heating, thereby being welded.

The resistance welding device 20 is configured to control the magnitude of the welding current with a time resolution on the order of milliseconds such that the magnitude of the welding current is varied in accordance with a preset welding current profile.

The welding apparatus 1 comprises a control system of the welding current, specifically, a resistance measurer 30, a current profile generator 40, and a welding controller 50.

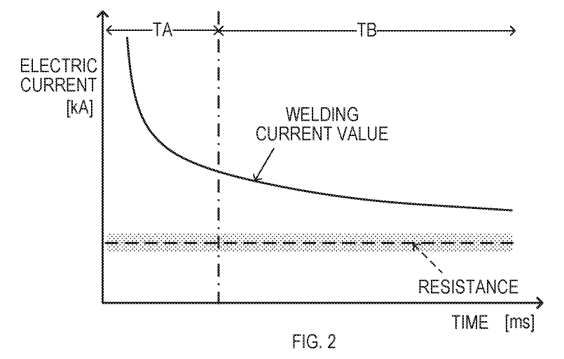

The welding controller 50 is configured to control the magnitude of the welding current during welding of the workpiece W. Specifically, the welding controller 50 varies the value of the welding current over time in accordance with the welding current profile, as illustrated in FIG. 2.

The welding current profile is divided into a high current application period TA and a main current application period TB. The high current application period TA corresponds to a period during which an application of the welding current is initiated. The main current application period TB corresponds to a period that follows the high current application period TA, during which welding is performed using the welding current.

During the high current application period TA, the welding current is set to a value higher than that required to weld the workpiece W. By using the welding current having such a value, contaminants on the first and second metal workpieces P1 and P2 are blown off. During the main current application period TB, the welding current is set to the value required to weld the workpiece W.

Specifically, the welding current is rapidly reduced from the maximum value to the required value during the high current application period TA, and is reduced more gradually during the main current application period TB than during the high current application period TA.

Specifically, at the beginning of the high current application period TA, the magnitude of the welding current is set to the maximum value of 10 kiloamperes or higher, for example, within 10 to 15 milliseconds, and is thereafter reduced to a required value (for example, 6 to 7 kiloamperes) along a curved profile over a specified time (for example, 50 to 60 milliseconds). During the main current application period TB, the magnitude of the welding current is gradually reduced, for example, from 6 to 7 kiloamperes to 5 kiloamperes within a specified time (for example, 300 to 400 milliseconds) after the welding is initiated. The above-described duration and values of the welding current may be varied appropriately depending on the number of metal workpieces included in the workpiece W, and respective thicknesses and/or respective materials of the metal workpieces.

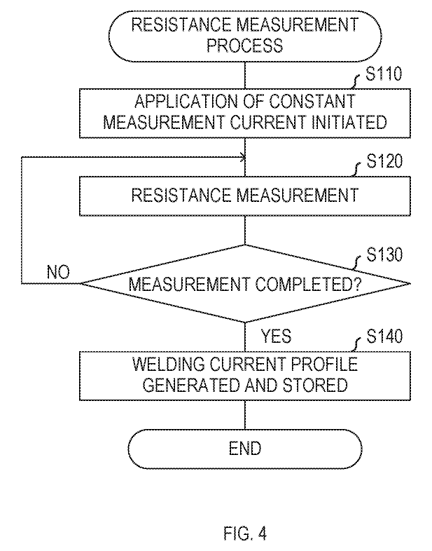

The current profile generator 40 is configured to generate (or set) the welding current profile. The resistance measurer 30 is configured to perform a resistance measurement process illustrated in FIG. 4 to thereby measure a resistance profile between the first and second electrodes 21 and 22 over time. The resistance profile is used by the current profile generator 40 to set the welding current profile.

The welding current profile is set by the time when the resistance welding device 20 initiates manufacturing the joined body under control of the welding controller 50.

As illustrated in FIG. 1, the resistance measurer 30 and the current profile generator 40 together with the welding controller 50 may be provided as functions of the welding apparatus 1. Alternatively, the resistance measurer 30 and the current profile generator 40 may be provided as functions of an additional welding apparatus separately from the welding apparatus 1. The additional welding apparatus comprises, similarly to the welding apparatus 1, the resistance welding device 20, and the first and second electrodes 21 and 22.

The additional welding apparatus may be installed in a manufacturing facility for manufacturing the joined body, together with the welding apparatus 1. Alternatively, the additional welding apparatus may be installed in a manufacturing facility separately from the welding apparatus 1. The additional welding apparatus may yet alternatively be installed in a control facility. The control facility controls welding conditions of welding apparatuses installed in one or more manufacturing facilities. Each of the welding apparatuses may be configured in the same manner as the welding apparatus 1.

The functions of the resistance measurer 30 and the current profile generator 40 are achieved by executing the resistance measurement process illustrated in FIG. 4 in the welding apparatus 1 or the additional welding apparatus. The resistance measurement process is executed in a state where a first combination of the first and second metal workpieces P1 and P2 is clamped between the first and second electrodes 21 and 22. The first combination of the first and second metal workpieces P1 and P2 is provided for use in the resistance measurement process. A second combination of the first and second metal workpieces P1 and P2 is provided, which is intended to be welded to form a joined body and is equivalent to the first combination.

As illustrated in FIG. 4, in response to the resistance measurement process being started, in S110 (S denotes Step), an application of constant measurement current is initiated between the first and second electrodes 21 and 22 via the resistance welding device 20. The constant measurement current is set to a value such that no welding spatter is generated on the workpiece W.

The resistance value between the first and second electrodes 21 and 22 is repeatedly measured in S120 until a specified measurement time has elapsed (i.e., until it is determined that the measurement is completed in S130). Measurement of the resistance value is performed by (i) obtaining the value of the voltage between the first and second electrodes 21 and 22 from the resistance welding device 20 and (ii) calculating the resistance value from the value of the voltage and the value of the constant measurement current.

When it is determined that the measurement is completed in S130 (S130: YES), the resistance measurement process proceeds to S140, where the application of the constant measurement current is stopped, and the welding current profile is generated based on time-series data of a series of the resistance values repeatedly measured in S120.

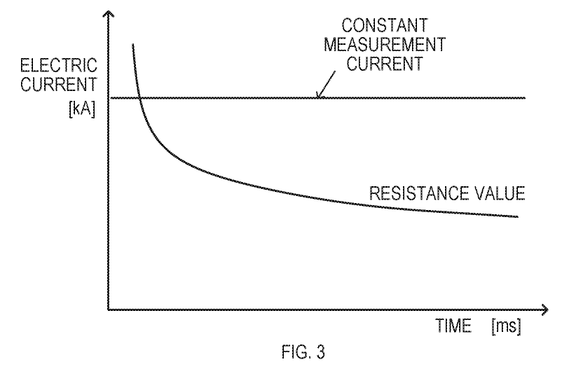

In S140, as shown in FIG. 3, the resistance profile is obtained from the time-series data of the series of the resistance values measured in S120. Subsequently, the welding current profile is set, as illustrated in FIG. 2, such that the magnitude of the welding current is varied over time with the same slope (or at the same change rate) as the resistance value. The welding current profile is stored as control data of the welding current in a storage medium, such as flash memory or a hard disk.

The process in S140 serves as the current profile generator 40. When the welding current profile is stored in the storage medium in S140, the resistance measurement process is ended.

The welding current profile stored in the storage medium is used by the welding controller 50 to control the magnitude of the welding current. The welding controller 50 may be configured such that a user can appropriately adjust the magnitude of the welding current based on the welding current profile set in the resistance measurement process.

### Effects Achieved by Embodiment

As described above, in the welding apparatus 1 according to the present embodiment, the constant measurement current is applied between the first and second electrodes 21 and 22 with the first combination of the first and second metal workpieces P1 and P2 clamped between the first and second electrodes 21 and 22. Accordingly, it is possible to measure, as the resistance profile, a rate at which the first combination of the first and second metal workpieces P1 and P2 heats up, a timing at which the heating is started, a timing at which the resistance reaches its peak after the heating is started, and a degree of current loss (current division) occurring afterward.

When welding the second combination of the first and second metal workpieces P1 and P2, which is equivalent to the first combination of the first and second metal workpieces P1 and P2, the welding controller 50 varies the magnitude of the welding current over time in accordance with the welding current profile corresponding to the resistance profile.

Thus, it is possible with the welding apparatus 1 to achieve, without monitoring variations in the resistance of the workpiece W during welding of the workpiece W, a constant-resistance welding (or a constant-resistance control of the resistance welding) in which the magnitude of the welding current is controlled such that the resistance between the first and second electrodes 21 and 22 is maintained at a substantially constant value, as illustrated in FIG. 2. Therefore, it is possible to reduce processing load on the welding controller 50 during welding. The welding conditions of the constant-resistance welding can be easily set through the resistance measurement process performed by the resistance measurer 30 and the current profile generator 40.

Since the resistance welding device 20 is capable of controlling the magnitude of the welding current with a time resolution on the order of milliseconds, the welding controller 50 can precisely control the magnitude of the welding current in accordance with the welding current profile. As a result, a better constant-resistance welding can be achieved.

The magnitude of the constant measurement current is set such that no welding spatter is generated. Accordingly, the magnitude of the welding current is also set such that no welding spatter is generated. As a result, the welding quality of the second combination of the first and second metal workpieces P1 and P2 can be improved.

As described above, the welding current during the high current application period TA is set to a value higher than that required to weld the workpiece W. As a result, contaminants on the second combination of the first and second metal workpieces P1 and P2 can be blown off during the high current application period TA, and the surfaces of the second combination of the first and second metal workpieces P1 and P2 can be more flattened. Therefore, it is possible to reduce the occurrence of welding spatter caused by contaminants during the main current application period TB.

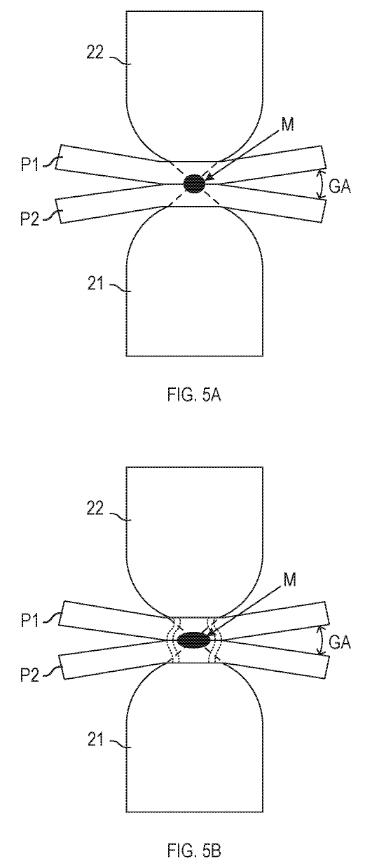

During the high current application period TA, the second combination of the first and second metal workpieces P1 and P2 generates heat due to the large welding current. As a result, a clearance GA as illustrated in FIG. 5A is formed between the first and second metal workpieces P1 and P2 around a welded portion M interposed between the first and second electrodes 21 and 22. This causes the welding current to be concentrated at the welded portion M. Thus, it is possible to reduce current loss caused by current flowing between the first and second metal workpieces P1 and P2 around the welded portion M.

While the magnitude of the welding current decreases, during the high current application period TA and the main current application period TB, along a curved profile that corresponds to the resistance profile, the welding current flows, as illustrated in FIG. 5B, through portions around the welded portion M where the first and second metal workpieces P1 and P2 are in contact with each other. The reason that the welding current flows in this manner is because the resistance at a center of the welded portion M increases due to melting of the workpiece W.

The flow of the welding current in this manner eliminates current loss and causes a weld nugget to form on the workpiece W. A diameter of the weld nugget can be controlled by shifting the welding current profile illustrated in FIG. 2 upward or downward.

### Modified Example

The present disclosure is not limited to the above-described embodiment, but can be implemented in various forms. For example, the above-described welding apparatus 1 may be used to weld three or more metal workpieces stacked in layers.

The welding current profile does not necessarily have to be set based on the previously measured resistance profile. The welding current profile may be set based on experiments or simulations.

A function performed by a single element in the aforementioned embodiment may be implemented by two or more elements. A function performed by two or more elements may be implemented by a single element. A part of the configuration of the aforementioned embodiment may be omitted. At least part of the configuration of the aforementioned embodiment may be added to or replaced with another part of the configuration of the same embodiment. It should be noted that any and all variations encompassed in the technical ideas defined by the language in the appended claims are considered embodiments of the present disclosure.

What is claimed is:

1. A method for manufacturing a joined body, the method comprising: clamping a first combination of metal workpieces between a first pair of electrodes, the first combination of metal workpieces including a high-strength steel sheet; and
applying a welding current between the first pair of electrodes in accordance with a preset current profile over time, the preset current profile being divided into (i) a high current application period, and (ii) a main current application period after the high current application period, the high current application period being a period during which a magnitude of the welding current is gradually reduced from its maximum value to a required value for welding the first combination of metal workpieces to blow contaminants off the first combination of metal workpieces, the main current application period being a period during which the magnitude of the welding current is reduced from the required value more gradually than during the high current application period to weld the first combination of metal workpieces.

2. The method according to claim 1, wherein:
the preset current profile is set to correspond to a resistance profile between a
second pair of electrodes over time;
the resistance profile is measured by (i) clamping a second combination of metal workpieces between the second pair of electrodes and (ii) applying a constant measurement current between the second pair of electrodes; and the second combination of metal workpieces is equivalent to the first combination of metal workpieces.

3. The method according to claim 2, wherein
the constant measurement current is set to a value such that no welding spatter
is generated on the second combination of metal workpieces.

4. The method according to claim 1, wherein
applying a welding current between the first pair of electrodes in accordance
with a preset current profile over time comprises using a welding apparatus capable of
controlling the magnitude of the welding current with a time resolution on the order of
milliseconds.
